(19) United States
(12) Patent Application Publication
(10) Pub. No.: US 2002/0144350 A1
(43) Pub. Date: Oct. 10, 2002

(54) Electric folding bed having adjustable bed frames

(76) Inventor: Long Time Shih, Chang Hua City (TW)

Correspondence Address: HARRISON & EGBERT, 412 MAIN STREET, 7TH FLOOR, HOUSTON, TX, 77002, US

(21) Appl. No.: 09/828,692

(22) Filed: Apr. 9, 2001

(51) Int. Cl. A61G 7/00; A61G 7/015

(52) U.S. Cl. 5/620; 5/618; 5/616

(57) ABSTRACT

An electric folding bed comprises a front bed frame, a rear bed frame, a pivoting structure for pivoting the front bed frame and the rear bed frame, and four adjustable legs for supporting the front bed frame and the rear bed frame on a surface. The adjustable legs are provided with an extensible rod and a drive device for driving the extensible rod to extend. The extensible rods are driven to extend simultaneously or independently so as to keep the bed frames in various positions.

### BACKGROUND OF THE INVENTION

1. Field of the Invention

The present invention relates generally to an electric folding bed, and more particularly to an electric folding bed having adjustable bed frames which are simple in construction and versatile in function.

2. Description of Related Art

As shown in FIG. 7, an electric folding bed of the prior art comprises a front bed frame 10 and a rear bed frame 11 The front bed frame 10 has two feet 12 opposite in location to each other, whereas the rear bed frame 11 has two feet 13 opposite in location to each other. The front bed frame 10 and the rear bed frame 11 are pivotally fastened by two connection plates 22 in conjunction with a plurality of bolts 221. The front bed frame 10 and the rear bed frame 11 can be thus turned toward each other for easy storage of the electric folding bed. The front bed frame 10 is provided on the upper side with a backrest 14 and a waistrest 15, and in the underside with a motor 17 having a transmission shaft 18 by means of which a movable tube 19 is actuated. The movable tube 19 is fastened with a swivel arm 20 and a steel cable 21 for actuating respectively the backrest 14 and the waistrest 15. The rear bed frame 11 is provided on the upper side with two adjustable leg pads 16.

The prior art electric folding bed described above is defective in design in that the backrest 14 and the leg pads 16 can be adjusted to a very limited extent, and that the front bed frame 10 and the rear bed frame 11 can not be adjusted in height, and further that the front bed frame 10 and the rear bed frame 11 are pivoted together by two pivoting structures which are complicated in construction and can not be easily assembled.

### BRIEF SUMMARY OF THE INVENTION

The primary objective of the present invention is to provide an electric folding bed which is free of the deficiencies of the prior art electric folding bed described above.

In keeping with the principle of the present invention, the foregoing objective of the present invention is attained by an electric folding bed comprising a front bed frame, a rear bed frame, a pivoting structure for pivoting the front bed frame and the rear bed frame, and four adjustable legs for supporting the front bed frame and the rear bed frame. The four adjustable legs are adjusted in length independently or simultaneously, so as to keep the bed frames in the position of an appropriate inclination.

The objective, features and functions of the present invention will be more readily understood upon a thoughtful deliberation of the following detailed description of the present invention in reference to the accompanying drawings.

### BRIEF DESCIPTION OF THE SEVERAL VIEWS OF TIE DRAWINGS

FIG. 1 shows a perspective view of a preferred embodiment of the present invention in combination.

FIGS. 2A, 2B and 2C are schematic views of the preferred embodiment of the present invention at work.

FIGS. 3A, 3B and 3C are another schematic views of the preferred embodiment of present invention at work.

FIG. 4 shows an exploded view of the pivoting structure of the present invention.

FIG. 5 shows a schematic view of the present invention in the folding state.

FIGS. 6A, 6B and 6C are schematic views of another preferred embodiment of the present invention at work.

FIG. 7 shows a perspective view of an electric folding bed of the prior art in combination.

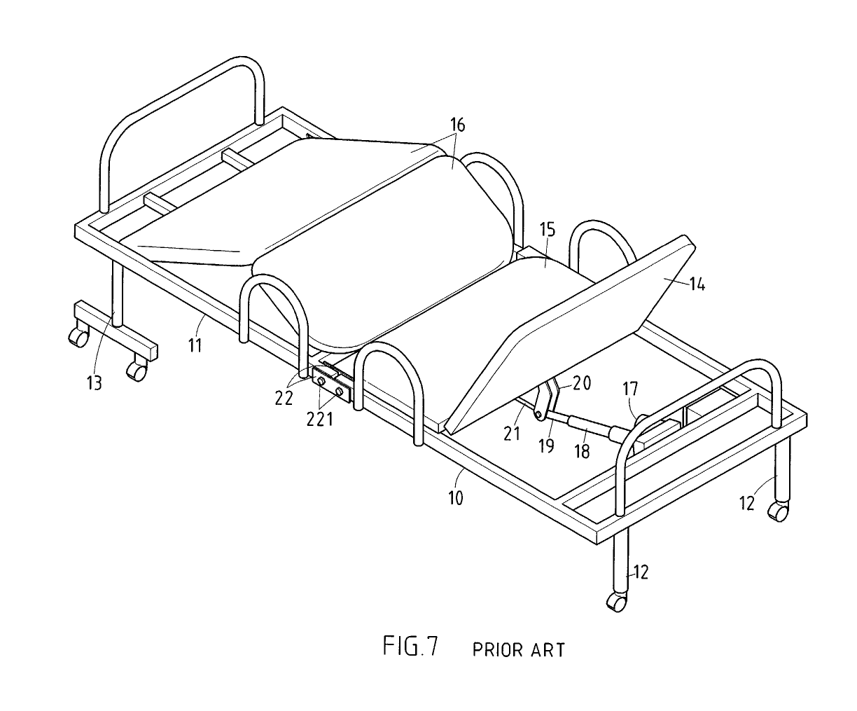

### DETAILED DESCRIPTION OF THE INVENTION

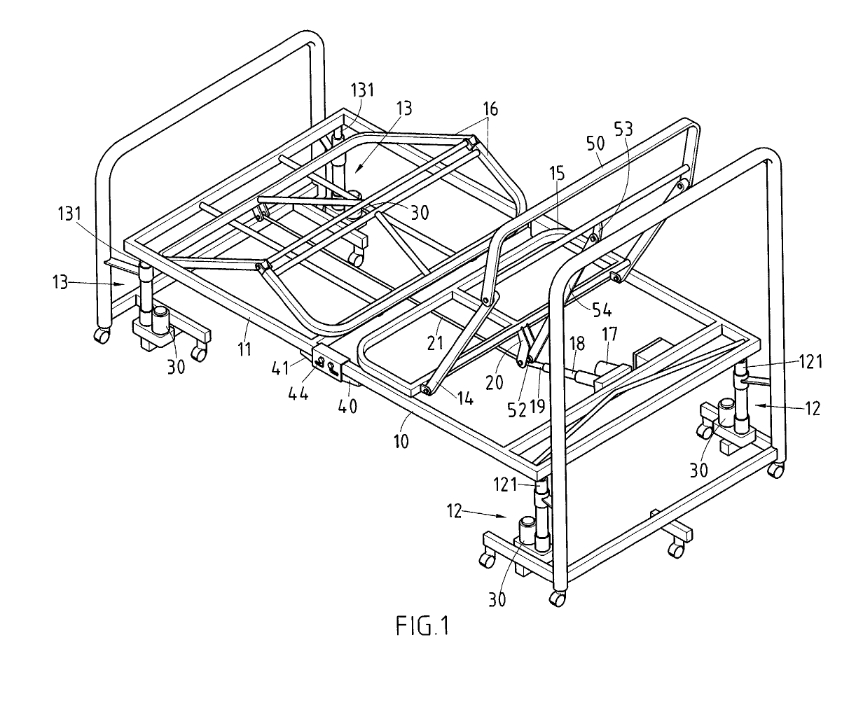

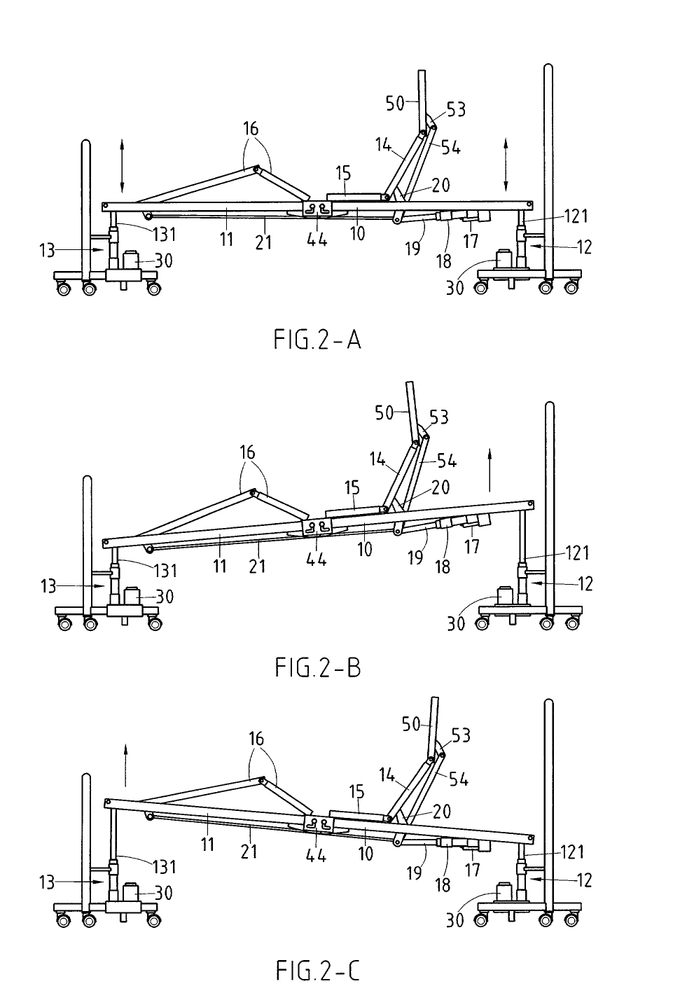

As shown in FIGS. 1-3, an electric folding bed embodied in the present invention comprises a front bed frame 10, a rear bed frame 11, a pivoting structure for pivoting the front bed frame 10 and the rear bed frame 11, two front legs 12 for supporting the front bed frame 10, two rear legs 13 for supporting the rear bed frame 11, and an electric device comprising a motor 17 with a transmission shaft 18. The front bed frame 10 is provided with a backrest 14 and a waistrest 15, whereas the rear bed frame II is provided with a footrest 16. The backrest 14 is actuated by a swivel arm 20 which is mounted on a movable tube 19. The movable tube 19 is fastened at one end with the transmission shaft 18, and at other end with a steel cable 21 which is fastened with the footrest 14.

The two front legs 12 are provided with an extensible rod 121 and a drive device 30 for driving the extensible rod 121 which hoists the front bed frame 10. Similarly, the two rear legs 13 are provided with an extensible rod 131 and a drive device 30 for driving the extensible rod 131 which hoists the rear bed frame 11.

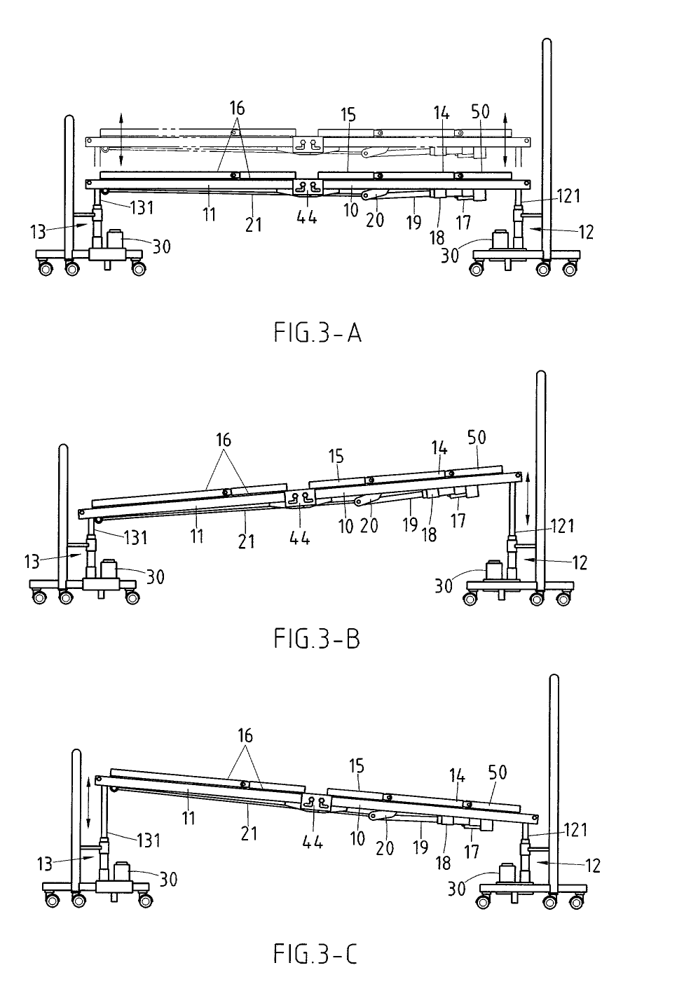

As illustrated in FIG. 3A, the extensible rods 121 of the two front legs 12 and the extensible rods 131 of the two rear legs 13 are extended upward simultaneously to lift the front bed frame 10 and the rear bed frame 11 at the same time. As a result, the front bed frame 10 and the rear bed frame 11 are located in a coplanar manner.

As illustrated in FIG. 3B, the extensible rods 121 of the two front legs 12 are independent of the extensible rods 131 of the two rear legs 13 in terms of extensibility. As a result the front bed frame 10 is hoisted to a level higher than that of the rear bed frame 11 such that the front bed frame 10 and the rear bed frame are kept in the position of an inclination.

As illustrated in FIG. 3C, the extensible rods 131 of the two rear legs 13 are independent of the extensible rods 121 of the two front legs 12 in terms of extensibility. As a result, the rear bed frame 11 is lifted to a level higher than that of the front bed frame 10 such that the rear bed frame 11 and the front bed frame 10 form an inclined plane.

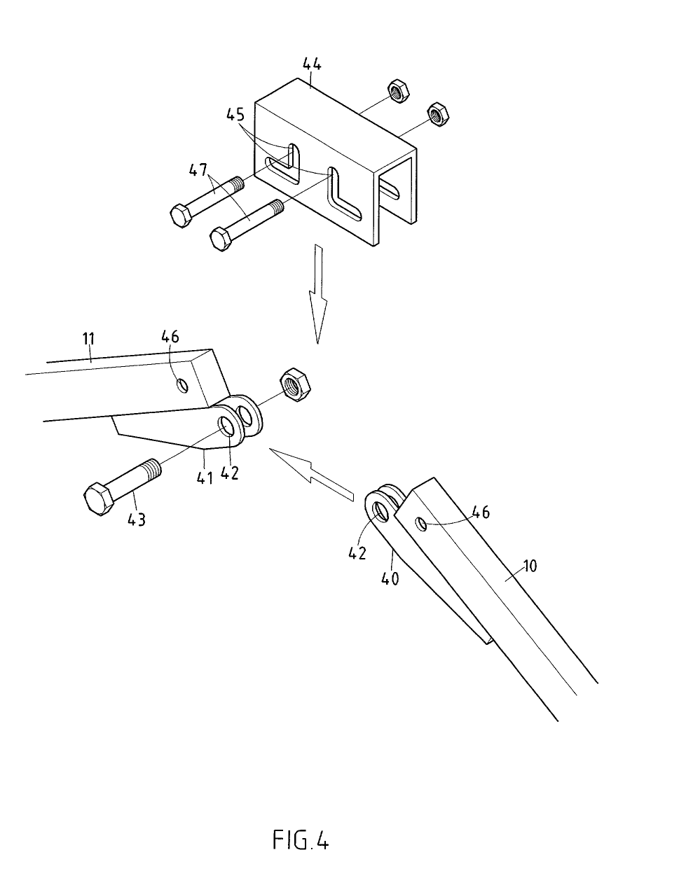

As shown in FIG. 4, the pivoting structure of the present invention comprises a front pivoting lug 40, a rear pivoting lug 41, an a pivot 43. The front pivoting lug 40 is fastened to the front bed frame 10 and is provided with a pivot hole 42. The rear pivoting lug 41 is fastened to the rear bed frame 11 and is provided with a pivot hole 42. The front bed frame 10 and the rear bed frame 11 are pivoted together by the pivot 43 which is put through the pivot holes 42 of the front pivoting lug 40 and the rear pivoting lug 41.

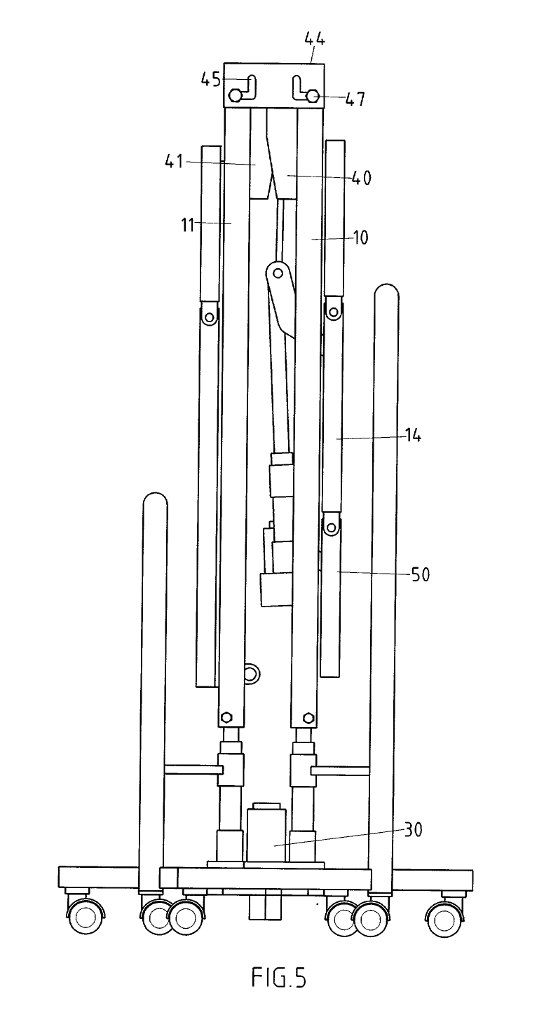

As shown in FIGS. 4 and 5, the pivoting structure of the present invention further comprises a cover plate 44 which has an inverted U-shaped cross section and is provided in two side walls with two through holes 45 corresponding in location to a through hole 46 of the front bed frame 10 and a through hole 46 of the rear bed frame 11. The cover plate 44 is pivotally fastened with the front bed frame 10 by a bolt body 47 which is put through the through holes 45 of the cover plate 44 and the through hole 46 of the front bed frame 10. The cover plate 44 is pivotally fastened with the rear bed frame II by another bolt body 47 which is put through another through holes 45 of the cover plate 44 and the through hole 46 of the rear bed frame 11.

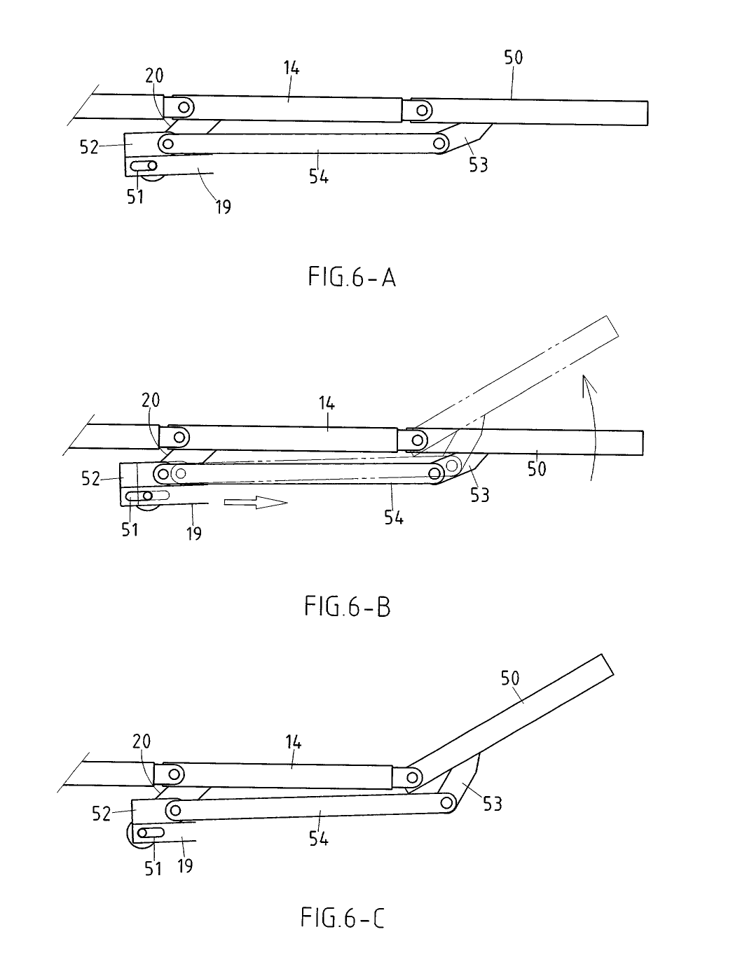

As shown in FIGS. 6A, 6B, and 6C, the backrest 14 is provided with a headrest 50 fastened therewith. The headrest 50 has a push arm 53. The movable tube 19 is provided with a position confining hole 51 and a pivoting portion 52 corresponding to the push arm 53. The push arm 53 and the pivoting potion 52 are connected by a transmission rod 54. When the backrest 14 is actuated by the movable tube 19 to locate in the horizontal position, the transmission rod 54 is kept being pushed by the pivoting portion 52 so as to push the headrest 50 upward. The headrest 50 can be thus used as a pillow.

As illustrated in FIG. 5, the folding bed of the present invention is folded by turning the front bed frame 10 and the rear bed frame 11 toward each other on the pivot 43 by which the front bed frame 10 and the rear bed frame 11 are pivoted together.

I claim:

1. An electric folding bed comprising:
a front bed frame provided with a backrest and a waistrest;
a rear bed frame provided with a footrest and pivoted with said front bed frame;
an electric device fastened with said front bed frame for actuating said backrest and said footrest;
two front legs for supporting said front bed frame on a surface; and
two rear legs for supporting said rear bed frame on the surface;
wherein said rear bed frame is pivoted with said front bed frame by a pivoting structure whereby said pivoting structure comprises a front pivoting lug, a rear pivoting lug, and a pivot, with said front pivoting lug being fastened to said front bed frame and provided with a pivot hole, with said rear pivoting lug being fastened to said rear bed frame and provided with a pivot hole, said rear bed frame and said front bed frame being pivoted together by said pivot which is put through said pivot hole of said front pivoting lug and said pivot hole of said rear pivoting lug;
wherein said two front legs are provided with an extensible rod and a drive device for driving said extensible rod which is fastened at a top end with the underside of said front bed frame;
wherein said two rear legs are provided with an extensible rod and a drive device for driving said extensible rod which is fastened at a top end with the underside of said rear bed frame.

2. The electric folding bed as defined in claim 1, wherein said extensible rods of said front legs and said rear legs are driven by said drive devices to extend upward simultaneously so as to locate said front bed frame and said rear bed frame in a coplanar manner.

3. The electric folding bed as defined in claim 1, wherein said extensible rods of said front legs are extended upward independently of said extensible rods of said rear legs, thereby enabling said front bed frame and said rear bed frame to form an inclined plane.

4. The electric folding bed as defined in claim 1, wherein said extensible rods of said rear legs are extended upward independently of said extensible rods of said front legs, thereby enabling said rear bed frame and said front bed frame to form an inclined plane.

5. The electric folding bed as defined in claim 1, wherein said pivoting structure further comprises a cover plate, a first bolt, and a second bolt, said cover plate having an inverted U-shaped cross section and provided in two side walls with two through holes corresponding in location to a through hole of said front bed frame and a through hole of said rear bed frame, said cover plate being fastened pivotally with said front bed frame by said first bolt which is put through said through holes of said cover plate and said through hole of said front bed frame, said cover plate being fastened pivotally with said rear bed frame by said second bolt which is put through another through holes of said cover plate and said through hole of said rear bed frame.

6. The electric folding bed as defined in claim 1, wherein said backrest is actuated by a movable tube connected to said electric device and is provided with a headrest fastened therewith, said headrest having a push arm, said movable tube having a position confining hole and a pivoting portion corresponding in location to said push arm, said push arm and said pivoting portion being connected by a transmission rod which is pushed by said pivoting portion to hoist said headrest at such time when said backrest is actuated by said movable tube to locate horizontally.
